(19) United States
(12) Patent Application Publication
(10) Pub. No.: US 2005/0219213 A1
(43) Pub. Date: Oct. 6, 2005

(54) Motion-based input device capable of classifying input modes and method therefor

(75) Inventors: Sung-jung Cho, Suwon-si (KR); Dong-yoon Kim, Seoul (KR); Jong-koo Oh, Yongin-si (KR); Won-chul Bang, Seongnam-si (KR); Joon-kee Cho, Yongin-si (KR); Wook Chang, Seoul (KR); Kyoung-ho Kang, Yongin-si (KR); Eun-seok Choi, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/094,217

(22) Filed: Mar. 31, 2005

(30) Foreign Application Priority Data
Apr. 1, 2004 (KR) 10-2004-0022557

(51) Int. Cl. G09G 5/08

(52) U.S. Cl. 345/158

(57) ABSTRACT

A motion-based input device includes an inertial sensor acquiring an inertial signal corresponding to a user's motion, a buffer unit buffering the inertial signal at predetermined intervals, a mode classifying unit extracting a feature from the buffered inertial signal and classifying an input mode as either of a continuous state input mode and a symbol input mode based on the extracted feature, and an input processing unit which processes the inertial signal according to the classified input mode to recognize either of a continuous state and a symbol and outputs an input control signal indicating either of the recognized continuous state and symbol. The inertial sensor includes at least one sensor among an acceleration sensor and an angular velocity sensor. The motion-based input device further includes an input button that functions as a switch allowing the user to input a motion.

### BACKGROUND OF THE INVENTION

This application claims the priority of Korean Patent Application No. 10-2004-0022557, filed on Apr. 1, 2004, in the Korean Intellectual Property Office, the disclosure of which is incorporated herein in its entirety by reference.

1. Field of the Invention

Apparatuses and methods consistent with the present invention relate to a motion-based input device, and more particularly, to a motion-based input device capable of classifying input modes into a continuous state input mode and a symbol input mode according to a user's motion and performing an input process in either of the continuous state input mode and the symbol input mode.

2. Description of the Related Art

A variety of devices are used to input a user's commands into electronic apparatus. For example, a remote control and buttons are used for a TV, and a keyboard and a mouse are used for a computer. Recently, a device has been developed that inputs a user's command into the electronic apparatus by using a user's motion. Such a motion-based input device recognizes a user's motion using built-in inertial sensors such as an acceleration sensor and an angular velocity sensor. For example, when a user tilts an input device, the input device senses continuous changes in its status with respect to a gravity direction and controls a cursor and a sliding bar on a display system, which may be referred to continuous state input. In addition, the input device analyzes a track of a user's motion performed with the input device and inputs a symbol such as a character or an instruction corresponding to the analyzed track, which may be referred to symbol input. A motion-based input device needs to support two input modes allowing for the continuous state input and the symbol input, respectively.

Conventional motion-based input devices can make a continuous state input and a symbol input but cannot discriminate them.

### SUMMARY OF THE INVENTION

Exemplary embodiments of the present invention provide a motion-based input device capable of classifying input modes into a continuous state input mode and a symbol input mode according to a user's motion and performing an input process in either of the continuous state input mode and the symbol input mode, and a method therefor.

According to an exemplary aspect of the present invention, there is provided a motion-based input device capable of classifying an input mode, including an inertial sensor which acquires an inertial signal corresponding to a user's motion, a buffer unit which buffers the inertial signal at predetermined intervals, a mode classifying unit which extracts a feature from the buffered inertial signal and classifies an input mode as either of a continuous state input mode and a symbol input mode based on the extracted feature, and an input processing unit which processes the inertial signal according to the classified input mode to recognize either of a continuous state and a symbol and outputs an input control signal indicating either of the recognized continuous state and the symbol. The inertial sensor may include at least one sensor among an acceleration sensor and an angular velocity sensor. The motion-based input device may further include an input button that functions as a switch allowing the user to input a motion. The buffer unit may include a buffer memory temporarily storing the inertial signal and a buffer controller controlling a section width and a shift width of a window used to buffer the inertial signal stored in the buffer memory at the predetermined intervals. The buffer controller may set the shift width of the window to be smaller than the section width of the window. The mode classifying unit may include a feature extractor extracting the feature from the inertial signal to recognize a pattern and a pattern recognizer recognizing a pattern from the extracted feature and outputting a value indicating either of the continuous state input mode and the symbol input mode.

The feature extractor may extract magnitudes of the inertial signal obtained at predetermined intervals and a maximum variation obtained using the magnitudes of the inertial signal as features of the inertial signal. The pattern recognizer may recognize the pattern from the extracted feature of the inertial signal using one among a neural network having a multi-layer perceptron structure, a support vector machine, a Bayesian network, or template matching. The mode classifying unit may classify the input mode as the continuous state input mode when a magnitude of the inertial signal extracted as the feature is less than a predetermined threshold and may classify the input mode as the symbol input mode when the magnitude of the inertial signal is equal to or greater than the predetermined threshold.

The input processing unit may include a continuous state input processor buffering the inertial signal at predetermined intervals when the input mode is the continuous state input mode and computing a state using the buffered inertial signal; and a symbol input processor buffering the inertial signal until an input is completed when the input mode is the symbol input mode, extracting a feature from the buffered inertial signal, and recognizing a pattern to recognize a symbol.

According to another exemplary aspect of the present invention, there is provided a motion-based input device capable of classifying an input mode, including an inertial sensor which acquires an inertial signal corresponding to a user's motion, a buffer unit which buffers the inertial signal until the user completes an input motion, a memory unit which stores symbols indicating a continuous state input mode and symbols indicating a symbol input mode, a mode classifying unit which compares the buffered inertial signal with the symbols stored in the memory unit and classifies an input mode as either of the continuous state input mode and the symbol input mode, and an input processing unit which processes an inertial signal generated by the user's subsequent motion according to the classified input mode to recognize either of a continuous state and a symbol and outputs an input control signal indicating either of the recognized continuous state and symbol.

According to still another exemplary aspect of the present invention, there is provided a motion-based input device capable of classifying an input mode, including a symbol input button which sets a symbol input mode, a continuous state input button which sets a continuous state input mode, an inertial sensor which acquires an inertial signal corresponding to a user's motion, a mode converter which sets an input mode according to which of the symbol input button and the continuous state input button is pressed, and an input processing unit which processes the inertial signal according to the input mode set by the mode converter to recognize either of a continuous state and a symbol and outputs an input control signal indicating either of the recognized continuous state and the symbol.

According to yet another exemplary aspect of the present invention, there is provided a motion-based input method capable of classifying an input mode, including acquiring an inertial signal corresponding to a user's motion, buffering the inertial signal at predetermined intervals, extracting a feature from the buffered inertial signal and classifying an input mode as either of a continuous state input mode and a symbol input mode based on the extracted feature, and processing the inertial signal according to the classified input mode to recognize either of a continuous state and a symbol and outputting an input control signal indicating either of the recognized continuous state and symbol.

According to a further exemplary aspect of the present invention, there is provided a motion-based input method capable of classifying an input mode, including acquiring an inertial signal corresponding to a user's motion, buffering the inertial signal until the user completes an input motion, comparing the buffered inertial signal with symbols stored in advance and classifying an input mode as either of a continuous state input mode and a symbol input mode, and processing an inertial signal generated by the user's subsequent motion according to the classified input mode to recognize either of a continuous state and a symbol and outputting an input control signal indicating either of the recognized continuous state and the symbol.

According to another exemplary aspect of the present invention, there is provided a motion-based input method capable of classifying an input mode, including setting an input mode to either of a symbol input mode and a continuous state input mode, acquiring an inertial signal corresponding to a user's motion, and processing the inertial signal according to the input mode to recognize either of a continuous state and a symbol and outputting an input control signal indicating either of the recognized continuous state and the symbol.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a motion-based input device capable of classifying input modes according to an exemplary embodiment of the present invention;

FIG. 2 is a flowchart of input processing performed by the motion-based input device shown in FIG. 1;

FIG. 3A is a graph showing an inertial signal acquired by an inertial sensor shown in FIG. 1;

FIG. 3B is a graph showing a section width and a shift width of a window for buffering the inertial signal;

FIG. 3C is a graph showing a result of classifying the inertial signal into modes;

FIG. 4 is a detailed flowchart of operation S240 shown in FIG. 2;

FIG. 5A is a graph showing a magnitude of an acceleration signal with respect to a continuous state input and a symbol input;

FIG. 5B is a graph showing a magnitude of an angular velocity signal with respect to a continuous state input and a symbol input;

FIG. 6 is a detailed flowchart of operation S260 shown in FIG. 2;

FIG. 7 is a detailed flowchart of operation S270 shown in FIG. 2;

FIG. 8 is a diagram of a structure of a neural network used in classing an input mode according to an exemplary embodiment of the present invention;

FIGS. 9A, 9B and 9C are graphs of inertial signals classified into a symbol input mode as a result of classifying an input mode;

FIGS. 9D, 9E and 9F are graphs of inertial signals classified into a continuous state input mode as a result of classifying an input mode;

FIG. 10 is a block diagram of a motion-based input device capable of classifying input modes according to another exemplary embodiment of the present invention;

FIG. 11A is a diagram illustrating volume control of an electronic apparatus that is displayed on a screen;

FIG. 11B illustrates an operation for volume control according to an exemplary embodiment of the present invention;

FIG. 11C illustrates an operation for volume control according to another exemplary embodiment of the present invention; and

FIG. 11D illustrates an operation for volume control according to still another exemplary embodiment of the present invention.

### DETAILED DESCRIPTION OF ILLUSTRATIVE, NON-LIMITING EMBODIMENTS OF THE INVENTION

Hereinafter, exemplary embodiments of the present invention will be described in detail with reference to the attached drawings.

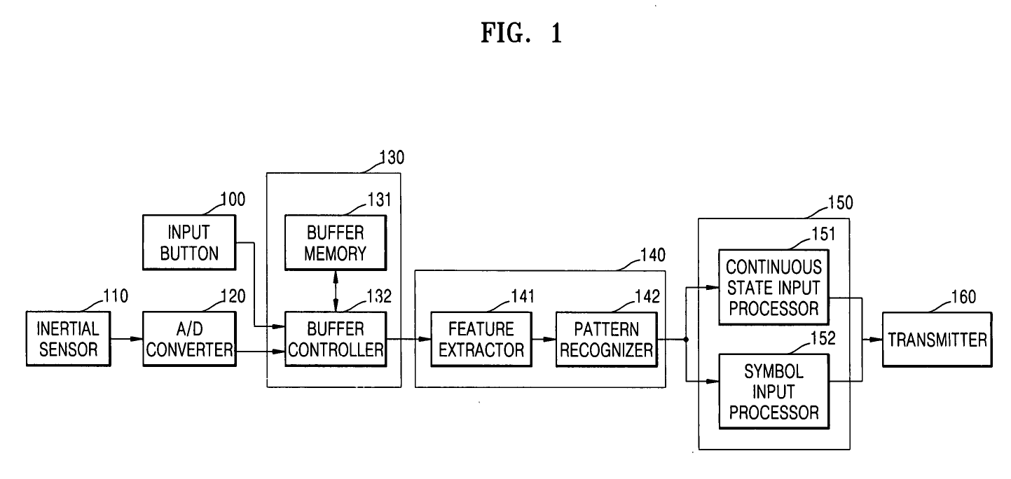

Referring to FIG. 1, a motion-based input device according to an exemplary embodiment of the present invention includes an input button 100, an inertial sensor 110, an analog-to-digital (A/D) converter 120, a buffer unit 130, a mode classifying unit 140, an input processing unit 150, and a transmitter 160.

The input button 100 is pressed by a user wishing to make a continuous state input or a symbol input using the motion-based input device. The input button 100 serves as a switch transmitting an inertial signal acquired by the inertial sensor 110 to the buffer unit 130 via the A/D converter 120.

The inertial sensor 110 acquires an acceleration signal and an angular velocity signal according to a motion of the motion-based input device. In exemplary embodiments of the present invention, the inertial sensor 110 includes both of an acceleration sensor and an angular velocity sensor. However, the inertial sensor 110 may include only one of them.

The A/D converter 120 converts the inertial signal acquired by the inertial sensor 110 in an analog format into a digital format and provides the inertial signal in the digital format to the buffer unit 130.

The buffer unit 130 buffers the inertial signal at predetermined intervals and includes a buffer memory 131 and a buffer controller 132. The buffer memory 131 temporarily stores the inertial signal. The buffer controller 132 controls a section width and a shift width of a window for buffering the inertial signal stored in the buffer memory 131.

The mode classifier 140 includes a feature extractor 141 and a pattern recognizer 142. The mode classifier 140 performs pre-processing and feature extraction on the buffered inertial signal and recognizes a pattern using a predetermined pattern recognition algorithm to classifying an input mode as either of a continuous state input mode and a symbol input mode.

Table 1 shows characteristics of the continuous state input mode and the symbol mode. The mode classifier 140 classifies input modes using the predetermined pattern recognition algorithm, which will be described later, based on these characteristics.

TABLE 1

| | Continuous state | |
|---|---|---|
| | input mode | Symbol input mode |
| Motion speed | Slow | Fast |
| Major acceleration | Gravity acceleration, | Gravity acceleration, |
| signal | Acceleration | Acceleration of hand |
| | of hand posture | motion |
| | change | |
| Acceleration | Small | Great |
| variation | | |
| Rotary motion | Mainly around | Mainly around two or |
| | single axis | more axes |

The input processing unit 150 includes a continuous state input processor 151 and a symbol input processor 152. When the input mode is the continuous state input mode, the input processing unit 150 calculates a status of the motion-based input device using an input signal for a predetermined period of time and outputs a control signal according to the calculated status. When the input mode is the symbol input mode, the input processing unit 150 recognizes a symbol input using the predetermined pattern recognition algorithm and outputs a control signal according to the recognized symbol input.

The transmitter 160 transmits the control signal received from the input processing unit 150 to an electronic apparatus to be controlled. The transmitter 160 may not be included in the motion-based input device. For example, when a motion-based input device is used as an external input device such as a remote control, it includes the transmitter 160. However, when a motion-based input device is used as an input device of a mobile phone, it does not need to include the transmitter 160.

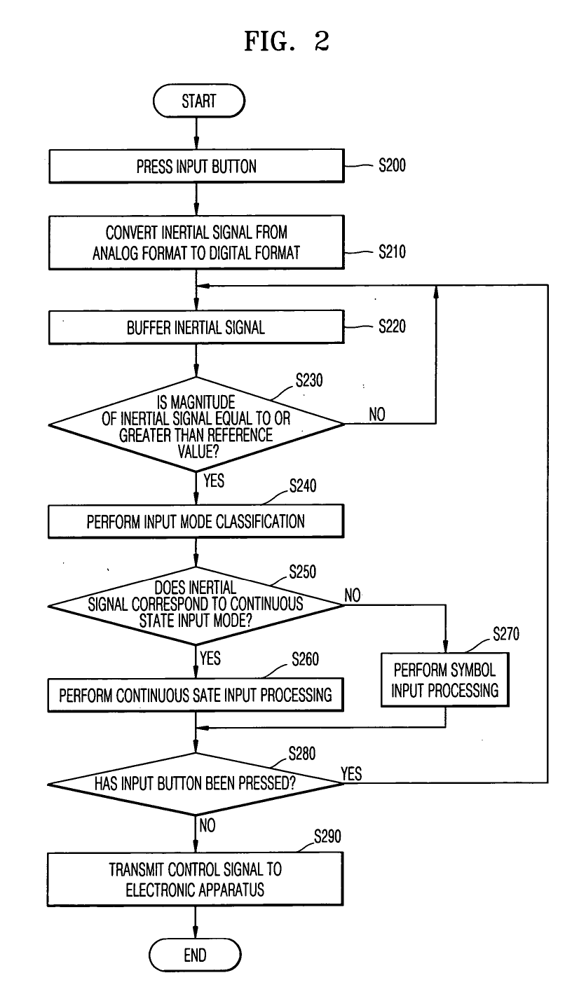

FIG. 2 is a flowchart of input processing performed by the motion-based input device shown in FIG. 1. Operations shown in FIG. 2 will be described in association with the motion-based input device shown in FIG. 1.

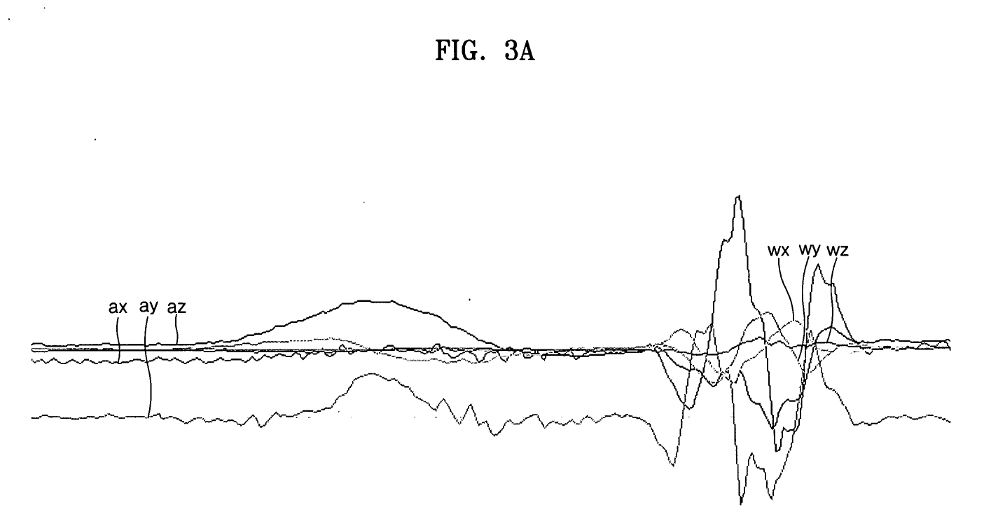

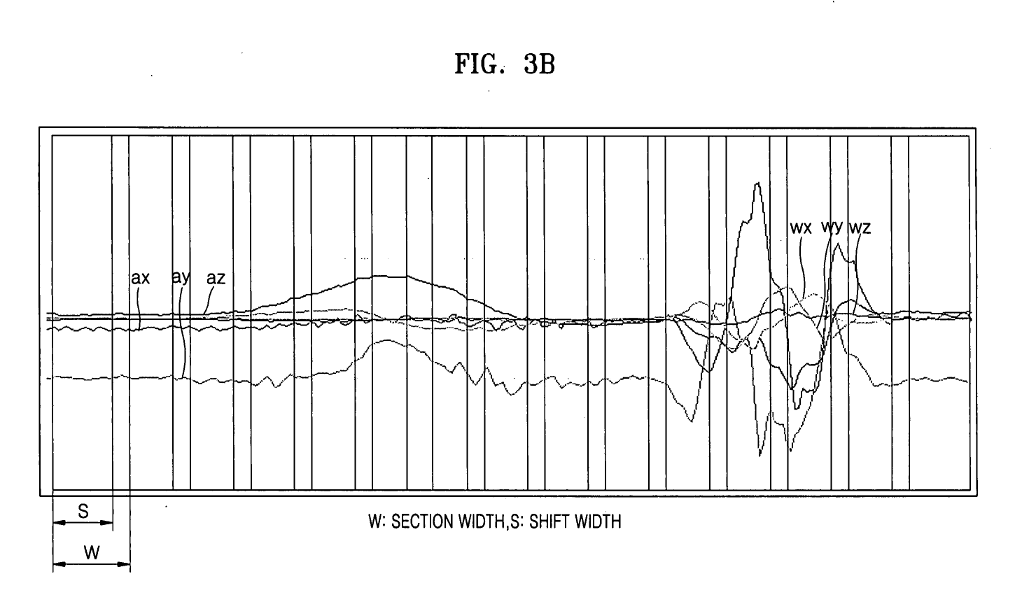

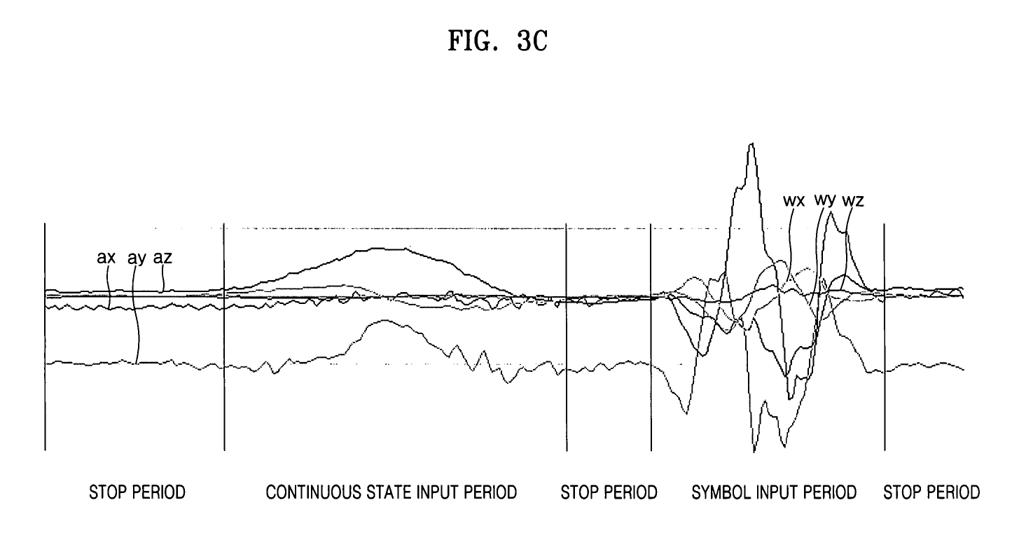

In operation S200, when a user presses the input button 100, an inertial signal acquired by the inertial sensor 110 is provided to the A/D converter 120. The acquired inertial signal may include acceleration signals acquired by the acceleration sensor included in the inertial sensor 110 and angular velocity signals acquired by the angular velocity sensor included in the inertial sensor 110. FIG. 3A is a graph showing three acceleration signals aₓ, a_{y}, and a_{z} and three angular velocity signals wₓ, w_{y}, and w_{z}, which are acquired by the inertial sensor 110. In operation S210, the A/D converter 120 converts the inertial signal acquired by the inertial sensor 110 in an analog format into a digital format. In operation S220, the buffer controller 132 temporarily stores the inertial signal in the digital format in the buffer memory 131, buffers the inertial signal by a predetermined section, i.e., a buffer window, and provides the buffered inertial signal to the mode classifying unit 140. FIG. 3B shows a section width W and a shift width S of the buffer window. The inertial signal stored in the buffer memory 131 is buffered by the section width W while the shift width S is less than the section width W, so a previous inertial signal is included in a succeeding classifying process. As a result, a result of mode classification is rapidly provided.

In operation S230, a magnitude of the buffered inertial signal is compared with a reference value. When it is determined that the magnitude of the buffered inertial signal is less than the reference value, the input processing returns to operation S220. When it is determined that the magnitude of the buffered inertial signal is equal to or greater than the reference value, the mode classifying unit 140 performs input mode classification with respect to the buffered inertial signal in operation S240.

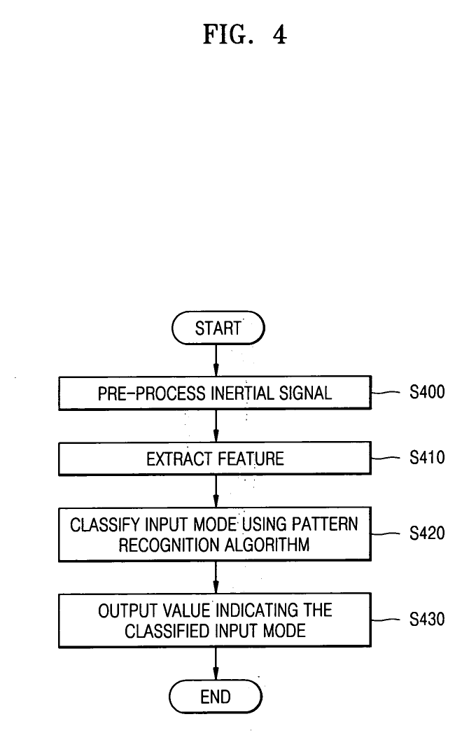

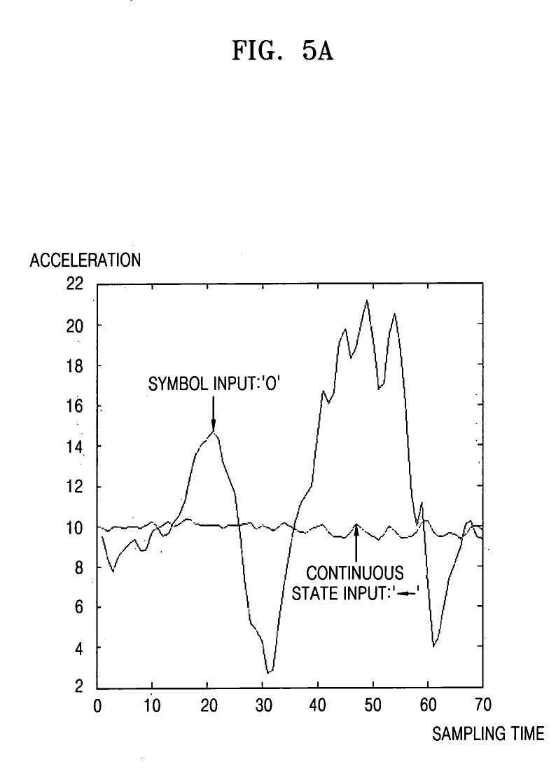

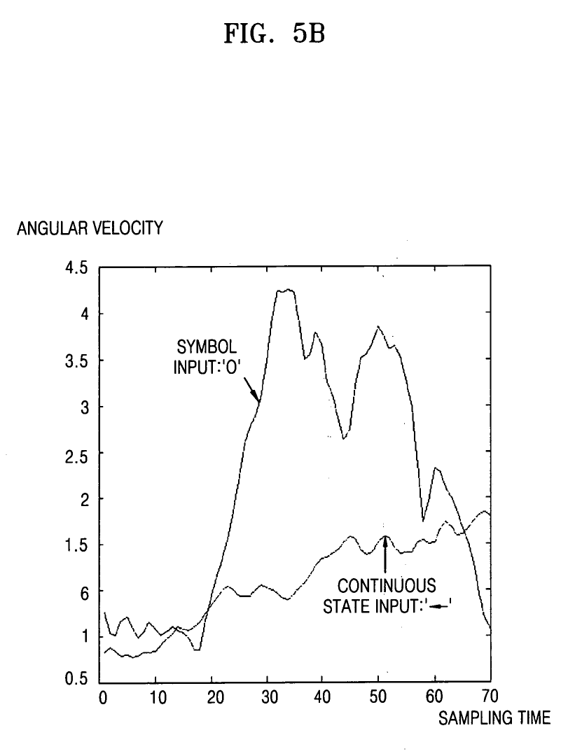

Operation S240 will be described in detail with reference to FIG. 4. Referring to FIG. 4, in operation S400, the buffered inertial signal including, for example, an acceleration signal shown in FIG. 5A and an angular velocity signal shown in FIG. 5B, is pre-processed. In an exemplary embodiment of the present invention, a low-pass filter is used to remove noise. In operation S410, a feature is extracted from the inertial signal. The feature extracted from a block[t, t+Δt] of the inertial signal can be expressed by Formulae (1) through (4).
[α(t), . . . , α(t+Δt)], α(t)=\sqrt{α_{X}(t)²+α_{y}(t)²+α_{z}(t)²} (1)
[ω(t), . . . , ω(t+Δt)], ω(t)=\sqrt{ωₓ(t)²+ω_{y}(t)²+ω_{z}(t)²} (2)
Δα(t)=maxₖ₌₀^{Δt}α(t+k)−minₖ₌₀^{Δt}α(t+k) (3)
Δω(t)=maxₖ₌₀^{Δt}ω(t+k)−minₖ₌₀^{Δt}ω(t+k) (4)

Here, α(t) denotes a magnitude of the acceleration signal at a time “t”, and ω(t) denotes a magnitude of the angular velocity signal at the time “t”.

According to Formulae (1) and (2), the acceleration signal and the angular velocity signal are sampled at predetermined intervals in the block [t, t+Δt], and a predetermined number of acceleration values and a predetermined number of angular velocity values are obtained as features. According to Formulae (3) and (4), maximum variations Δα(t) and Δω(t) of the acceleration signal and the angular velocity signal in the block [t, t+αt] are obtained as features. The features of the acceleration signal and the angular velocity signal are extracted using Formulae (1) through (4) but may be extracted in terms of different values than Formulae (1) through (4).

In operation S420, a current input mode is classified using a predetermined pattern recognition algorithm. A variety of pattern recognition algorithms have been developed so far and can be applicable to the mode classification.

For clarity of the description, if it is assumed that an N-dimensional input vector, i.e., a feature extracted by the feature extractor 141 is X=[X₁, . . . , Xₙ], a 42-dimensional vector can be expressed by Formula (5).
X=[X₁, . . . , X₄₂]=[α(t), . . . , α(t+19), ω(t), . . . , ω(t+19), Δα(t), Δω(t)] (5)

When the continuous state input mode is set to 0 and the symbol input mode is set to 1, class C={0,1} can be defined.

An exemplary pattern recognition method is usually performed in a procedure similar to that described below.

First, a large amount of data about {Input X, Class C} is collected from a user. Secondly, the collected data is classified into learning data and test data. Thirdly, the learning data is presented to a pattern recognition system to perform a learning process. Here, model parameters of the pattern recognition system are changed in accordance with the learning data. Lastly, only an input X is presented to the pattern recognition system to make the pattern recognition system output a class C.

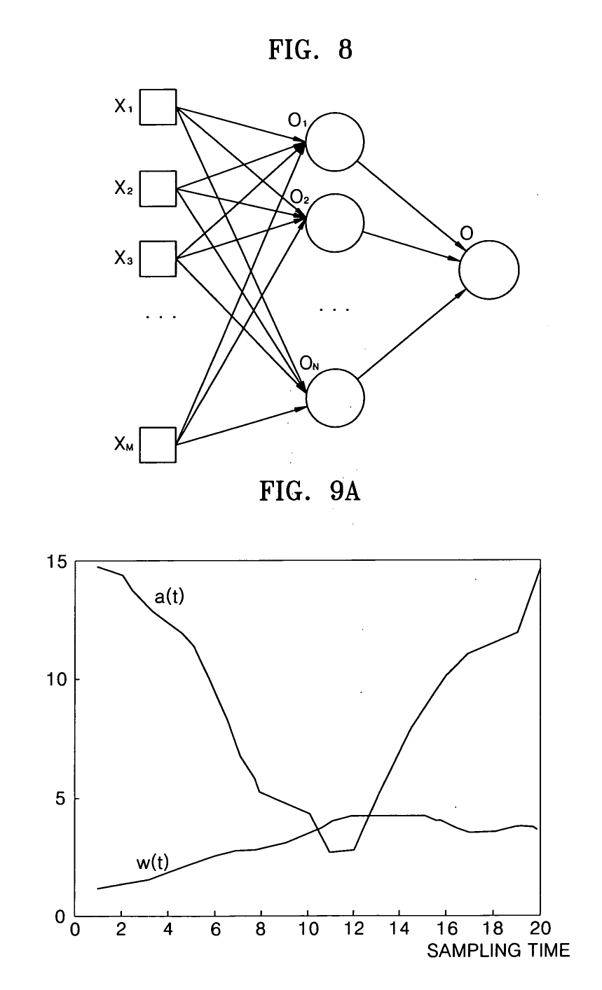

The following description concerns exemplary embodiments of the present invention using different pattern recognition algorithms. In a first exemplary embodiment of the present invention, a method of classifying input modes uses a neural network that is an algorithm of processing information in a similar manner to a human brain. FIG. 8 is a diagram of a structure of a neural network used in classing an input mode according to an exemplary embodiment of the present invention. The neural network uses a multi-layer perceptron structure. Reference characters x₁, X₂, . . . , Xₙ denote feature values extracted from an inertial signal which are included in an input layer. Reference characters O₁, O₂, . . . , O_{M} denote results of performing a non-linear function of linear combinations of the feature values received from the input layer and are included in a hidden layer. The hidden layer sends the results of the non-linear function to an output layer O. O₁ is computed using Formula (6).

$${O}_{1} = f ( {b}_{1} + {\sum }_{i = 1}^{N} {ω}_{i 1} {x}_{i} ) \qquad ( 6 )$$

Here, the function f(x) is defined by Formula (7), b1 is a constant, and ωᵢ₁ is a weight that is determined through learning. O₂ through O_{M} can be computed in the same manner using Formula (6).

$$f ( x ) = \frac{1}{1 + {ⅇ}^{- x}} \qquad ( 7 )$$

The output layer O can be computed using Formula (8).

$$O = f ( {c}_{1} + {\sum }_{j = 1}^{M} {υ}_{j 1} {O}_{j} ) \qquad ( 8 )$$

Here, the function f(x) is defined by Formula (7), c₁ is a constant, and υᵢ₁ is a weight that is determined through learning. The output layer O has a value ranging from 0 to 1. When the output layer O has a value exceeding 0.5, an input mode is determined as the symbol input mode. When the output layer O has a value not exceeding 0.5, an input mode is determined as the continuous state input mode. FIG. 3C is a graph showing a result of classifying an input signal into modes.

In exemplary experiments of the present invention, 4 input types (i.e., ←, →, ↑ and ↓) and 80 data items were used for a continuous state input, and 10 input types (i.e., 0 through 9) and 55 data items were used for a symbol input. Learning data was ⅔ of entire data, and test data was ⅓ of the entire data.

Table 2 shows results obtained when the section width W was 20 points, the shift width S was 10 points, and the multi-layer perceptron structure was 42*15*1.

Recognized input

| | | Continuous |
|---|---|---|
| Original input | Symbol input | state input |
| Symbol input | 86 | 3 |
| Continuous state input | 10 | 165 |

The number of inputs shown in Table 2 is different from the number of test data because a plurality of mode classifications are performed on a single input when the section width W is 20 points and the shift width S is 10 points. According to the results shown in Table 2, a recognition ratio with respect to each of the symbol input and the continuous state input is 95.1%.

Table 3 shows results obtained when the section width W was 30 points, the shift width S was 10 points, and the multi-layer perceptron structure was 62*15*1.

TABLE 3

Recognized input

| | | Continuous |
|---|---|---|
| Original input | Symbol input | state input |
| Symbol input | 71 | 0 |
| Continuous state input | 6 | 143 |

According to the results shown in Table 3, a recognition ratio with respect to each of the symbol input and the continuous state input is 97.3%.

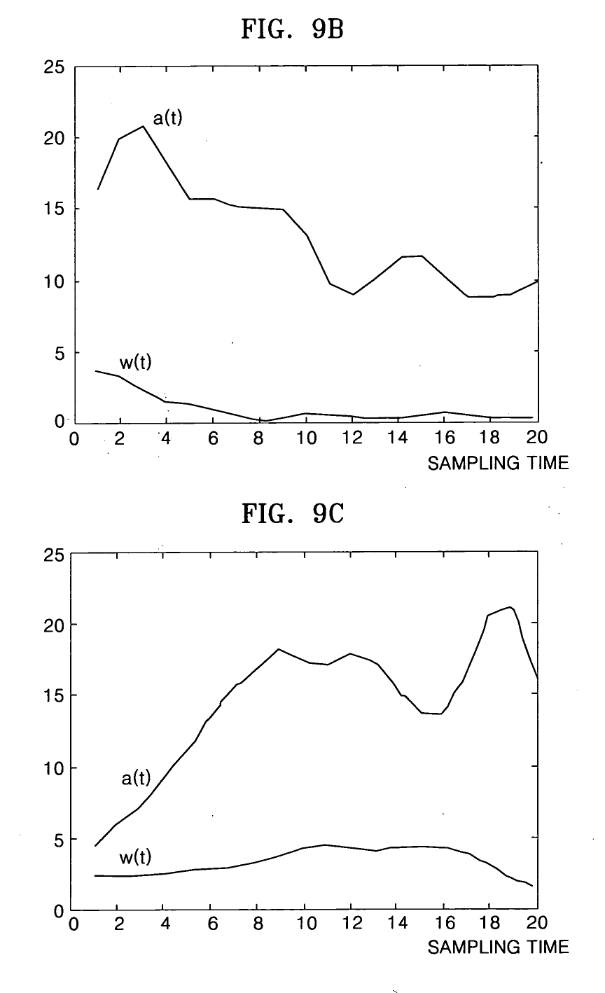

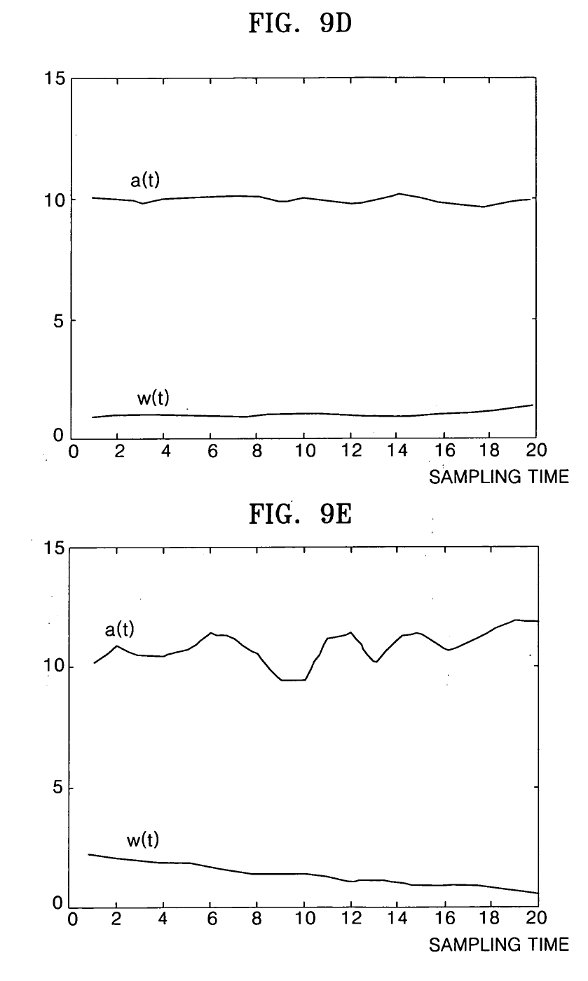

FIGS. 9A through 9C are graphs of inertial signals classified into the symbol input mode as a result of classifying an input mode using a neural network. FIG. 9A is a graph of an inertial signal indicating a symbol “0”. FIG. 9B is a graph of an inertial signal indicating a symbol “1”. FIG. 9C is a graph of an inertial signal indicating a symbol “9”. FIGS. 9D through 9F are graphs of inertial signals classified into the continuous state input mode as a result of classifying an input mode using a neural network. FIG. 9D is a graph of an inertial signal indicating a continuous state “←”. FIG. 9E is a graph of an inertial signal indicating a continuous state “↑”. FIG. 9F is a graph of an inertial signal indicating a continuous state “↓”.

In a second exemplary embodiment of the present invention, an input mode can be classified using a support vector machine in operation S420. In the second embodiment, an N-dimensional space is formed based on N features of an inertial signal. Next, an appropriate hyperplane is found based on learning data. Next, the input mode is classified using the hyperplane and can be defined by Formula (9).
class=1 if W^{T}X+b≧0
class=0 if W^{T}X+b>0 (9)

Here, W is a weight matrix, X is an input vector, and “b” is an offset.

In a third exemplary embodiment of the present invention, an input mode can be classified using a Bayesian network in operation S420. In the third embodiment, a probability of each input mode is computed using a Gaussian distribution of feature values of an inertial signal. Then, the inertial signal is classified into an input mode having a highest probability. The Bayesian network is a graph of random variables and dependence relations among the variables. A probability of an input model can be computed using the Bayesian network.

When an input mode is the continuous state input mode, a probability of an input is expressed by Formula (10).

$$P ( {X}_{1} = {x}_{1} , … , {X}_{n} = {x}_{n} \vert C = 0 ) = {\prod }_{i = 1}^{n} P ( {X}_{i} = {x}_{i} \vert C = 0 ) \qquad ( 10 )$$

When an input mode is the symbol input mode, a probability of an input is expressed by Formula (11).

$$P ( {X}_{1} = {x}_{1} , … , {X}_{n} = {x}_{n} \vert C = 1 ) = {\prod }_{i = 1}^{n} P ( {X}_{i} = {x}_{i} \vert C = 1 ) \qquad ( 11 )$$

Assuming that the probability distribution P(Xᵢ=xᵢ|C=c) complies with a Gaussian distribution having a mean of μc, and a dispersion of Σc, Formula (12) can be obtained.
P(Xᵢ=xᵢ|C=c)=N(xᵢ; μ_{c}, Σ_{c}) (12)

When learning is performed with respect to a plurality of data items, a mean and a dispersion are learned with respect to probability distribution P(Xᵢ=xᵢ|C=c).

If P(X₁=x₁, . . . , Xₙ=xₙ|C=0)≧P(X₁=x₁, . . . , Xₙ=xₙ|C=1), the input mode is classified as the continuous state input mode (i.e., class 0). If not, the input mode is classified as the symbol input mode (i.e., class 1).

In a fourth exemplary embodiment of the present invention, an input mode can be classified using template matching in operation S420. In the fourth embodiment, template data items as which input modes are respectively classified are generated using learning data. Then, a template data item at a closest distance from a current input is found, and an input mode corresponding to the found template data item is determined for the current input. In other words, with respect to an i-th data item Yᵢ=P(y₁, . . . , yₙ) among input data X=P(x₁, . . . , xₙ) and the learning data, Y* can be defined by Formula (13).
Y*=minᵢDistance(X,Yᵢ) (13)

Here, Distance(X,Y) can be expressed by Formula (14).

$$Distance ( X , Y ) = ‖ X - Y ‖ = \sqrt{{\sum }_{i = 1}^{n} {( {x}_{i} - {y}_{i} )}^{2}} \qquad ( 14 )$$

If Y* is data included in the symbol input mode, the input X is classified as the symbol input mode. If Y* is data included in the continuous state input mode, the input X is classified as the continuous state input mode.

In a fifth exemplary embodiment of the present invention, an input mode can be classified using a simple rule-based method in operation S420. In the fifth embodiment, if an inertial signal is equal to or greater than a predetermined threshold, an input mode is classified as the symbol input mode. If the inertial signal is less than the predetermined threshold, the input mode is classified as the continuous state input mode. This operation can be defined by Formula (15).
1if Δα(t)≧Thₐor Δω(t)≧Th_{w}0otherwise (15)

Here, Thₐ is a threshold of acceleration and Th_{w} is a threshold of an angular velocity.

Besides the above-described pattern recognition algorithms, other various pattern recognition algorithms can be used in the present invention.

In operation S430, a value indicating the continuous state input mode or the symbol input mode is output according to the result of classifying the input mode using a pattern recognition algorithm.

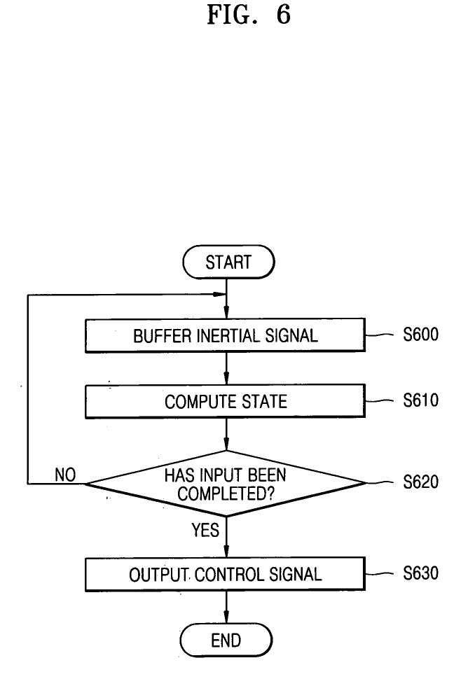

Referring back to FIG. 2, in operation S250, it is determined whether the inertial signal corresponds to the continuous state input mode. If the inertial signal corresponds to the continuous state input mode, the continuous state input processor 151 performs continuous state input processing in operation S260. FIG. 6 is a detailed flowchart of operation S260 shown in FIG. 2. In operation S600, the inertial signal is buffered for a predetermined period of time. In operation S610, a state (i.e., a coordinate point) on a display screen is computed using the inertial signal. The state on the display screen can be computed by performing integration two times on an acceleration signal included in the inertial signal or by performing integration two times on an angular velocity signal included in the inertial signal and then performing appropriate coordinate conversion. In operation S620, it is determined whether the input has been completed. When the user does not make any input motion, inputs a symbol, or releases the pressed input button 100, it is determined that the input has been completed. If it is determined that the input has not been completed, the method returns to operation S600. If it is determined that the input has been completed, the input processing unit 150 outputs an input control signal.

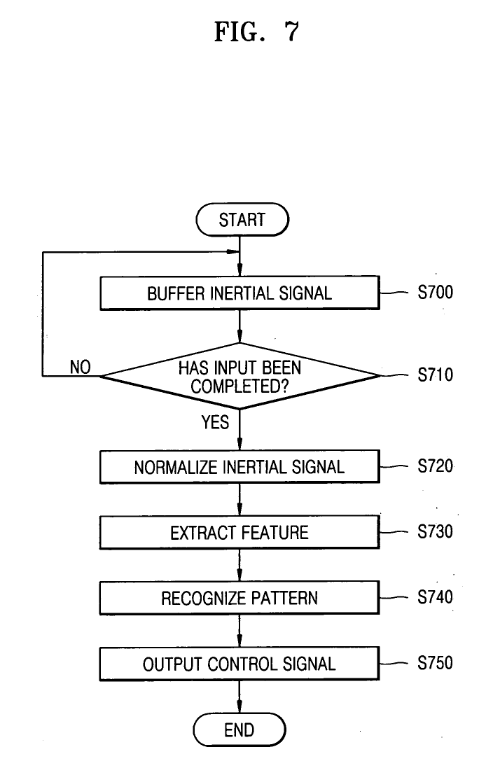

If the inertial signal does not correspond to the continuous state input mode, that is, if the inertial signal corresponding to the symbol input mode, the symbol input processor 152 performs symbol input processing in operation S270. FIG. 7 is a detailed flowchart of operation S270 shown in FIG. 2. In operation S700, the inertial signal is buffered. In operation S710, it is determined whether the input has been completed. When the user does not make any input motion, inputs a continuous state, or releases the pressed input button 100, it is determined that the input has been completed. If it is determined that the input has not been completed, the method returns to operation S700. If it is determined that the input has been completed, the magnitude of the inertial signal is normalized since the user's input motion may be large or small. In operation S730, a feature is extracted from the normalized inertial signal. In operation S740, pattern recognition is performed. Operations S730 and S740 are performed in the same manner as feature extraction and pattern recognition are performed to classify the input mode, and thus a description thereof will be omitted. However, two input modes are defined in the mode classification, while 10 numbers from 0 to 9 are recognized, as described in one of the above-described exemplary embodiments, in the pattern recognition. When necessary, other symbols may be recognized in addition to the 10 numbers. The symbol input processor 152 stores a feature of the inertial signal with respect to each of the 10 symbols in advance and compares the feature extracted in operation S730 with the stored features of the inertial signal to perform pattern recognition. In operation S750, the input processing unit 150 outputs an input control signal.

Referring back to FIG. 2, after the continuous state input processing or the symbol input processing, in operation S280, it is determined whether the input button 100 has been pressed. When it is determined that the input button 100 has been pressed by the user wanting to make an additional input, the method returns to operation S220.

When it is determined that the input button 100 has not been pressed and there is no additional input, in operation S290, the transmitter 160 transmits the input control signal from the input processing unit 160 via a wired or wireless connection to an electronic apparatus. In the case of a wired connection, a serial port may be used for transmission. In the case of a wireless connection, an infrared (IR) signal may be used.

In another exemplary embodiment of the present invention, a motion-based input device may have a similar structure to the motion-based input device according to the embodiment illustrated in FIG. 1, that includes the input button 100, the inertial sensor 110, the A/D converter 120, the buffer unit 130, the mode classifying unit 140, the input processing unit 150, and the transmitter 160, with the following exceptions. A memory unit (not shown) storing symbols indicating the continuous state input mode and symbols indicating the symbol input mode is further provided inside or outside the mode classifying unit 140. In addition, the buffer unit 130 buffers an inertial signal until a user completes an input motion corresponding to a symbol indicating either of the continuous state input mode and the symbol input mode. Then, the mode classifying unit 140 compares the buffered inertial signal with the symbols stored in the memory unit and classifies an input mode using the symbol recognition method performed in the symbol input processing (S270) by the motion-based input device according to the embodiment illustrated in FIG. 1. Thereafter, the input processing unit 150 processes an inertial signal generated by the user's subsequent motion, recognizes a continuous state or a symbol corresponding to the processed inertial signal, and outputs an input control signal indicating the continuous state or the symbol, which are the same operations as those performed by the input processing unit 150 of the motion-based input device according to the embodiment illustrated in FIG. 1.

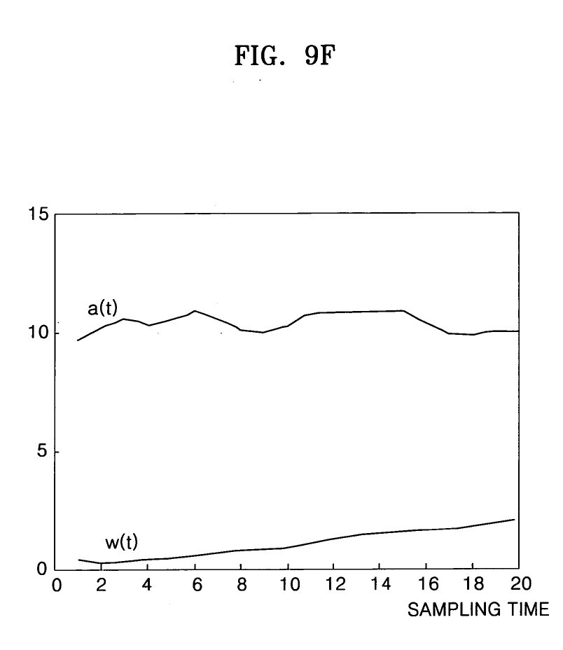

FIG. 10 is a block diagram of a motion-based input device capable of classifying input modes according to still another exemplary embodiment of the present invention. The motion-based input device includes a continuous state input button 1000, a symbol input button 1005, an inertial sensor 1010, an AID converter 1020, a mode converter 1030, an input processing unit 1050, and a transmitter 1060. Unlike the motion-based input device illustrated in FIG. 1, the motion-based input device illustrated in FIG. 10 includes the continuous state input button 1000 that functions as a switch allowing a continuous state to be input and the symbol input button 1005 that functions as a switch allowing a symbol to be input. Accordingly, the buffer unit 130 and the mode classifying unit 140 illustrated in FIG. 1 are not needed, but the mode converter 1030 is provided to convert a mode according to which of the continuous state input button 1000 and the symbol input button 1005 is pressed.

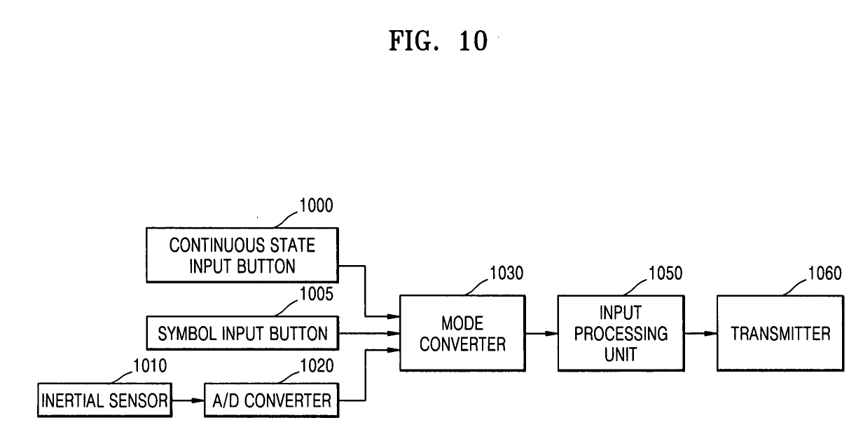

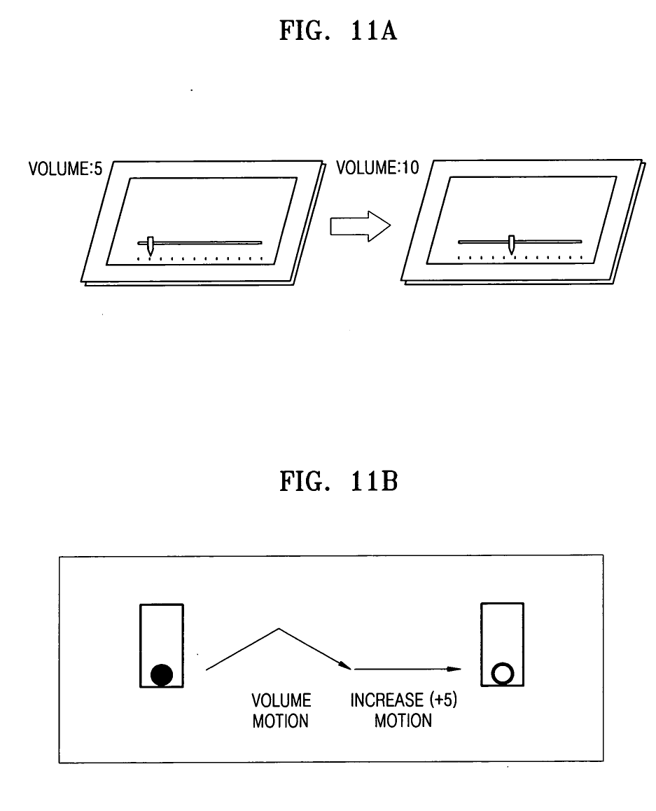

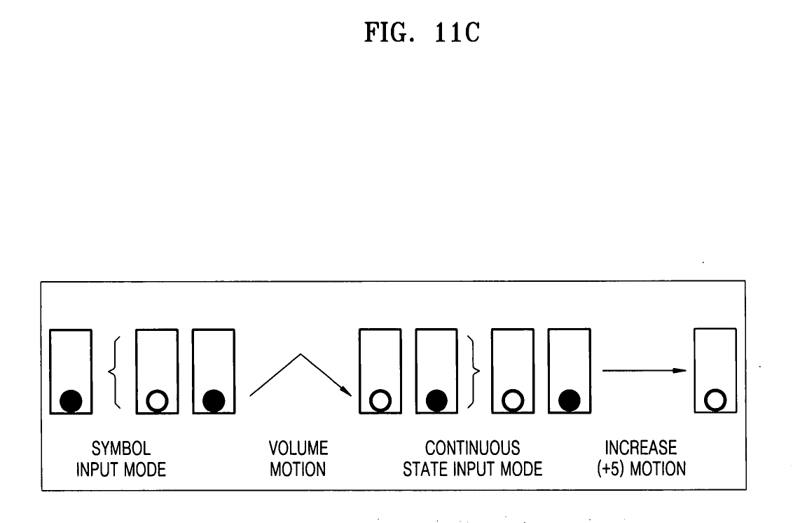

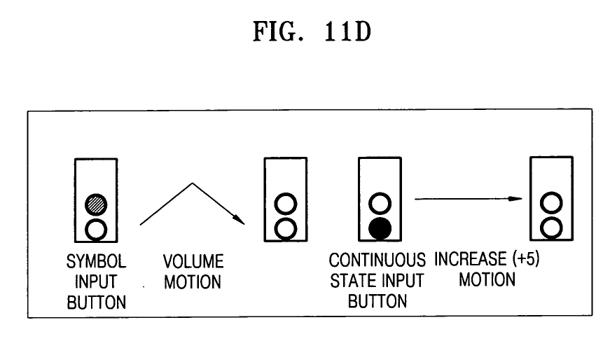

Operational differences among embodiments of the present invention will be described with reference to FIGS. 11A through 11D.

FIG. 11A is a diagram illustrating a screen displaying a volume of an electronic apparatus that is changed from level 5 to level 10. FIG. 11B illustrates an operation for volume control according to an exemplary embodiment of the present invention. Referring to FIG. 11B, a user presses an input button, makes a symbol input motion indicating volume, inputs a continuous state corresponding to a left-to-right direction to increase the volume, and then releases the input button. Here, the user can control the volume most easily, but as surveyed through the experiments, errors may occur in mode classification.

FIG. 11C illustrates an operation for volume control according to another exemplary embodiment of the present invention. A user presses an input button and makes a symbol input motion indicating the symbol input mode. Thereafter, the user presses the input button again and makes a continuous state input motion indicating the continuous state input mode. Thereafter, the user presses the input button once more and inputs a continuous state corresponding to the left-to-right direction to increase the volume. Here, since the user needs to make many motions, the user's convenience is decreased. However, errors occurring in mode classification are decreased.

FIG. 11D illustrates an operation for volume control according to still another exemplary embodiment of the present invention. A user presses a symbol input button and makes a symbol input motion indicating volume. Thereafter, the user presses a continuous state input button and inputs a continuous state corresponding to the left-to-right direction to increase the volume. Here, two input buttons are needed, but errors in mode classification is minimized.

According to the exemplary embodiments of the present invention, an input mode is classified as either of a continuous state input mode and a symbol input mode according to a user's input motion, and input processing is appropriately performed in the classified input mode. As a result, the user can conveniently make an input to an electronic apparatus using a motion-based input device.

While the present invention has been particularly shown and described with reference to exemplary embodiments thereof, it will be understood by those of ordinary skill in the art that various changes in forms and details may be made therein without departing from the spirit and scope of the present invention as defined by the following claims.

1. A motion-based input device capable of classifying an input mode, comprising:
an inertial sensor which acquires an inertial signal corresponding to a motion;
a buffer unit which buffers the inertial signal at predetermined intervals;
a mode classifying unit which extracts a feature from the buffered inertial signal and classifies an input mode as either of a continuous state input mode and a symbol input mode based on the extracted feature; and
an input processing unit which processes the inertial signal according to the classified input mode to recognize either of a continuous state and a symbol, and outputs an input control signal which indicates either of the recognized continuous state and the symbol.

2. The motion-based input device of claim 1, wherein the inertial sensor comprises at least one of an acceleration sensor and an angular velocity sensor.

3. The motion-based input device of claim 1, further comprising an input button that functions as a switch allowing the motion to be input.

4. The motion-based input device of claim 1, wherein the buffer unit comprises:
a buffer memory which temporarily stores the inertial signal; and
a buffer controller which controls a section width and a shift width of a window used to buffer the inertial signal stored in the buffer memory at the predetermined intervals.

5. The motion-based input device of claim 4, wherein the buffer controller sets the shift width of the window to be smaller than the section width of the window.

6. The motion-based input device of claim 1, wherein the mode classifying unit comprises:
a feature extractor which extracts the feature from the inertial signal to recognize a pattern; and
a pattern recognizer which recognizes a pattern from the extracted feature and outputs a value which indicates either of the continuous state input mode and the symbol input mode.

7. The motion-based input device of claim 6, wherein the feature extractor extracts magnitudes of the inertial signal obtained at predetermined intervals and a maximum variation obtained using the magnitudes of the inertial signal, as features of the inertial signal.

8. The motion-based input device of claim 6, wherein the pattern recognizer recognizes the pattern from the extracted feature of the inertial signal using a neural network having a multi-layer perceptron structure.

9. The motion-based input device of claim 6, wherein the pattern recognizer recognizes the pattern from the extracted feature of the inertial signal using a support vector machine.

10. The motion-based input device of claim 6, wherein the pattern recognizer recognizes the pattern from the extracted feature of the inertial signal using a Bayesian network.

11. The motion-based input device of claim 6, wherein the pattern recognizer recognizes the pattern from the extracted feature of the inertial signal using template matching.

12. The motion-based input device of claim 1, wherein the mode classifying unit classifies the input mode as the continuous state input mode if a magnitude of the inertial signal extracted as the feature is less than a predetermined threshold and classifies the input mode as the symbol input mode if the magnitude of the inertial signal is equal to or greater than the predetermined threshold.

13. The motion-based input device of claim 1, wherein the input processing unit comprises:
a continuous state input processor which buffers the inertial signal at predetermined intervals if the input mode is the continuous state input mode and computes a state using the buffered inertial signal; and
a symbol input processor which buffers the inertial signal until an input is completed if the input mode is the symbol input mode, extracts a feature from the buffered inertial signal, and recognizes a pattern to recognize a symbol.

14. A motion-based input device capable of classifying an input mode, comprising:
an inertial sensor which acquires an inertial signal corresponding to a motion;
a buffer unit which buffers the inertial signal until the motion is completed;
a memory unit storing symbols which indicates a continuous state input mode and symbols indicating a symbol input mode;
a mode classifying unit which compares the buffered inertial signal with the symbols stored in the memory unit and classifies an input mode as either of the continuous state input mode and the symbol input mode; and
an input processing unit which processes an inertial signal generated by a subsequent motion according to the classified input mode to recognize either of a continuous state and a symbol, and outputs an input control signal indicating either of the recognized continuous state and the symbol.

15. The motion-based input device of claim 14, wherein the inertial sensor comprises at least one of an acceleration sensor and an angular velocity sensor.

16. The motion-based input device of claim 15, further comprising an input button that functions as a switch allowing the motion to be input.

17. A motion-based input device capable of classifying an input mode, comprising:
a symbol input button which sets a symbol input mode;
a continuous state input button which sets a continuous state input mode;
an inertial sensor which acquires an inertial signal corresponding to a motion;
a mode converter which sets an input mode according to which of the symbol input button and the continuous state input button is pressed; and
an input processing unit which processes the inertial signal according to the input mode set by the mode converter to recognize either of a continuous state and a symbol and outputs an input control signal indicating either of the recognized continuous state and the symbol.

18. A motion-based input method capable of classifying an input mode, comprising:
acquiring an inertial signal corresponding to a motion;
buffering the inertial signal at predetermined intervals;
extracting a feature from the buffered inertial signal and classifying an input mode as either of a continuous state input mode and a symbol input mode based on the extracted feature; and
processing the inertial signal according to the classified input mode to recognize either of a continuous state and a symbol, and outputting an input control signal indicating either of the recognized continuous state and the symbol.

19. The motion-based input method of claim 18, wherein the inertial signal comprises at least one of an acceleration signal and an angular velocity signal.

20. A motion-based input method capable of classifying an input mode, comprising:
acquiring an inertial signal corresponding to a motion;
buffering the inertial signal until the motion is completed;
comparing the buffered inertial signal with stored symbols and classifying an input mode as either of a continuous state input mode and a symbol input mode; and
processing an inertial signal generated by a subsequent motion according to the classified input mode to recognize either of a continuous state and a symbol, and outputting an input control signal indicating either of the recognized continuous state and the symbol.

21. The motion-based input method of claim 20, wherein the inertial signal comprises at least one of an acceleration signal and an angular velocity signal.

22. A motion-based input method capable of classifying an input mode, comprising:
setting an input mode to either of a symbol input mode and a continuous state input mode;
acquiring an inertial signal corresponding to a motion; and
processing the inertial signal according to the input mode to recognize either of a continuous state and a symbol and outputting an input control signal indicating either of the recognized continuous state and the symbol.

23. The motion-based input method of claim 22, wherein the inertial signal comprises at least one of an acceleration signal and an angular velocity signal.
